(19) United States
(12) Patent Application Publication
(10) Pub. No.: US 2013/0119764 A1
(43) Pub. Date: May 16, 2013

(54) MODULARIZED POWER CONTROL DEVICE

(71) Applicants: Chien-Wei Hsu, Taipei (TW); Chia-Hao Chang, Taipei (TW); Chia-Wen Hsu, Taipei (TW); Hao-Yen Kuanch, Taipei (TW)

(72) Inventors: Chien-Wei Hsu, Taipei (TW); Chia-Hao Chang, Taipei (TW); Chia-Wen Hsu, Taipei (TW); Hao-Yen Kuanch, Taipei (TW)

(73) Assignee: INVENTEC CORPORATION, Taipei (TW)

(21) Appl. No.: 13/346,537

(22) Filed: Jan. 9, 2012

(30) Foreign Application Priority Data
Nov. 11, 2011 (TW) 100141269

(51) Int. Cl. H02J 4/00

(52) U.S. Cl. 307/43

(57) ABSTRACT

A modularized power control device for a computer system includes an upper plate, a lower plate, a first connecting unit and a second connecting unit. The upper plate has a first voltage converter for converting a first voltage into a plurality of first operating voltages. The lower plate has a second voltage converter and a fan control module. The second voltage converter is configured to receive a second voltage and convert the second voltage into a plurality of second operating voltages. The fan control module is configured to control operations of a plurality of heat dissipation fans inside the computer system. The first connecting unit is configured to connect a plurality of power lines of the upper plate and power lines of the lower plate. The second connecting unit is configured to connect a plurality of signal lines of the upper plate and signal lines of the lower plate.

### CROSS-REFERENCE TO RELATED APPLICATIONS

This non-provisional application claims priority under 35 U.S.C. §119(a) on Patent Application No(s). 100141269 filed in Taiwan, R.O.C. on Nov. 11, 2011, the entire contents of which are hereby incorporated by reference.

### BACKGROUND

1. Technical Field

The present disclosure relates to a power control device and more particularly to a modularized power control device.

2. Related Art

Generally, a computer system is allocated with a power supply for providing the computer system an operating voltage for normal operation. Furthermore, a computer system requires various voltage levels for supplying operating power required by various circuit elements on the motherboard. Therefore, a power distribution board is disposed between the motherboard and the power supply to convert a voltage supplied by the power supply into various voltages with different levels for the various circuit elements on the motherboard.

Furthermore, various circuit elements of the computer system generate heat during operation and thus the temperature inside the computer system increases. The various circuit elements inside the computer system may get damaged if the temperature inside the computer system can not be reduced effectively. Therefore, in order to reduce the temperature inside the computer system, a heat dissipation fan and a fan control board (FCB) are disposed inside the computer system, and the heat dissipation fan is controlled by the fan control board to dissipate the heat generated by the various power elements.

However, the inventors recognized that there is limited space inside the computer system, and the fan control board and the power distribution board are disposed separately, thus the assembling of the fan control board and the power distribution board is complicated and thus increases assembling difficulty. Furthermore, signal lines are needed to connect the fan control board to the power distribution board for signal transmission. Due to various types and numbers of the signal lines, the use cost of the circuit elements will increase and the designing for the circuit elements will become inconvenient.

### SUMMARY

The present disclosure provides a modularized power control device for a computer system. The modularized power control device comprises an upper plate, a lower plate, a plurality of power lines, a plurality of signal lines, a first connecting unit and a second connecting unit. The upper plate has a first voltage converter for receiving a first voltage and converting the first voltage into a plurality of first operating voltages required by the computer system. The lower plate has a second voltage converter and a fan control module The second voltage converter is configured to receive a second voltage and convert the second voltage into a plurality of second operating voltages required by the computer system. The fan control module is configured to control operations of a plurality of heat dissipation fans inside the computer system. The plurality of power lines are disposed on the upper plate and the lower plate respectively, and are coupled to the first voltage converter and the second voltage converter. The plurality of signal lines are disposed on the upper plate and the lower plate respectively. The signal lines on the lower plate are coupled to the fan control module. The first connecting unit is configured to connect the power lines of the upper plate and the power lines of the lower plate. The second connecting unit is configured to connect the signal lines of the upper plate and the signal lines of the lower plate.

The present disclosure will become more fully understood by reference to the following detailed description thereof when read in conjunction with the attached drawings.

### BRIEF DESCRIPTION OF THE DRAWINGS

The present disclosure will become more fully understood from the detailed description given herein below for illustration only, and thus are not limitative of the present disclosure, and wherein:

FIG. 1 is a block diagram of a modularized power control device of the disclosure; and

FIG. 2 is a structural perspective view of the modularized power control device of the disclosure.

### DETAILED DESCRIPTION

To resolve the above mentioned problems, the disclosure provides a modularized power control device by which the usage cost of circuit elements can be reduced.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

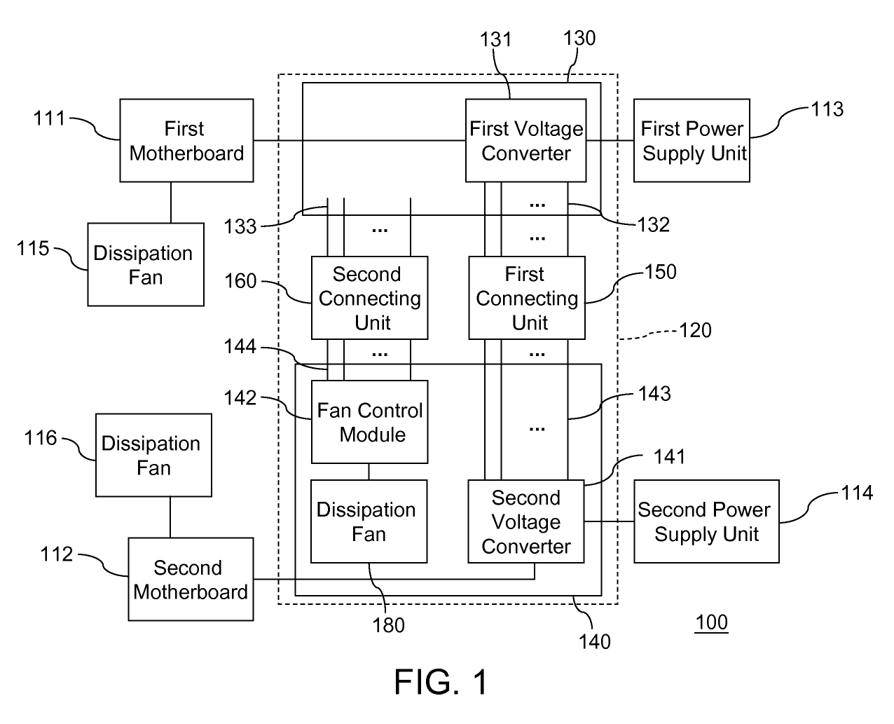

FIG. 1 is a block diagram of a computer system of the present disclosure. The computer system 100 comprises a first motherboard 111, a second motherboard 112, a first power supply unit (PSU) 113, a second power supply unit 114 and a modularized power control device 120. The first power supply unit 113 is configured to supply a first voltage, and the second power supply unit 114 is configured to supply a second voltage.

The modularized power control device 120 comprises an upper plate 130, a lower plate 140, a plurality of power lines 132 and 143, a plurality of signal lines 133 and 144, a first connecting unit 150 and a second connecting unit 160. In this embodiment, the upper plate 130 and the lower plate 140 may be printed circuit boards (PCBs).

The upper plate 130 has a first voltage converter 131 for receiving the first voltage supplied by the first power supply unit 113 and converting the first voltage into a plurality of first operating voltages required by the computer system 100. The first operating voltage is supplied to, for example, the first motherboard 111 for its normal operation. The upper plate 130 may be a power distribution board (PDB).

The lower plate 140 has a second voltage converter 141 and a fan control module 142. The second voltage converter 141 is configured to receive the second voltage supplied by the second power supply unit 114 and convert the second voltage into a plurality of second operating voltages required by the computer system 100. The second operating voltage is supplied to, for example, the second motherboard 112 for its normal operation.

The fan control module 142 is configured to control operations of a plurality of heat dissipation fans inside the computer system 100, such as a heat dissipation fan 115 disposed on the first motherboard 111 and a heat dissipation fan 116 disposed on the second motherboard 112. For example, the heat dissipation fans disposed on the first motherboard 111 and the second motherboard 112 are controlled by the fan control module 142 in order to effectively dissipate the heat generated by elements of the first motherboard 111 and the second motherboard 112, thereby reducing the temperature inside the computer system 100.

In this embodiment, the second voltage converter 141 and the fan control module 142 are electrically connected with each other by metal lines on the lower plate 140 instead of connecting lines. In such a case, the use cost of the connecting lines can be decreased.

The power line 132 is disposed on the upper plate 130 and is coupled to the first voltage converter 131 for voltage transmission. The power line 143 is disposed on the lower plate 140 and is coupled to the second voltage converter 141 for voltage transmission. The signal line 133 is disposed on the upper plate 130 for transmitting signals other than voltage signals (e.g. fan control signals, etc.). FIG. 1 only briefly shows that the disposition of the signal line 133 is disposed on the upper plate 130, but the signal line 133 in this embodiment can be connected to, for examples, other circuit elements on the upper plate 130 and circuit elements (e.g. central processing unit) on the first motherboard 111 for signals transmission.

The signal line 144 is disposed on the lower plate 140 and is coupled to the fan control module 142 for transmitting control signals generated by the fan control module 142 or other control signals. Furthermore, the signal line 144 can also be coupled to, in addition to the fan control module 142, other circuit elements on the lower plate 140 and circuit elements (e.g. central processing unit) on the second motherboard 112 for signals transmission.

The first connecting unit 150 is coupled between the upper plate 130 and the lower plate 140 for connecting the power line 132 of the upper plate 130 and the power line 143 of the lower plate 140, so that a voltage generated by the upper plate 130 can be transmitted to the lower plate 140 for use by the first connecting unit 150, and a voltage generated by the lower plate 140 can be transmitted to the upper plate 130 for use by the first connecting unit 150. As a result, when the first power supply unit 113 (or the second power supply unit 114) occurs an error or is damaged, the upper plate 130 (or the lower plate 140) can acquire a voltage generated by the lower plate 140 (or the upper plate 130) by the first connecting unit 150, or acquire the second voltage (or the first voltage) supplied by the second power supply unit 114 (or the first power supply unit 113), so that the computer system 100 can still operate normally. In this embodiment, the first connecting unit 150 can be a bridging card for easily assembling and disassembling of the upper plate 130 and the lower plate 140.

Furthermore, the second connecting unit 160 is coupled between the upper plate 130 and the lower plate 140 for connecting the signal line 133 of the upper plate 130 and the signal line 144 of the lower plate 140. As a result, the fan control module 142 can transmit signals to the upper plate 130 or receive signals from the upper plate 130 by the second connecting unit 160. For example, when a detecting unit of the first motherboard 111 detects that the temperature of the first motherboard 111 is too high, the detected signal can be transmitted to the fan control module 142 of the lower plate 140 by the upper plate 130 and the second connecting unit 160. Then, the fan control module 142 generates a corresponding control signal and sends the control signal to the first motherboard 111 by the second connecting unit 160 and the upper plate 130, in order to control and speed up a turning speed of the heat dissipation fan 115 of the first motherboard 111. Therefore, the temperature of the first motherboard 111 is effectively reduced.

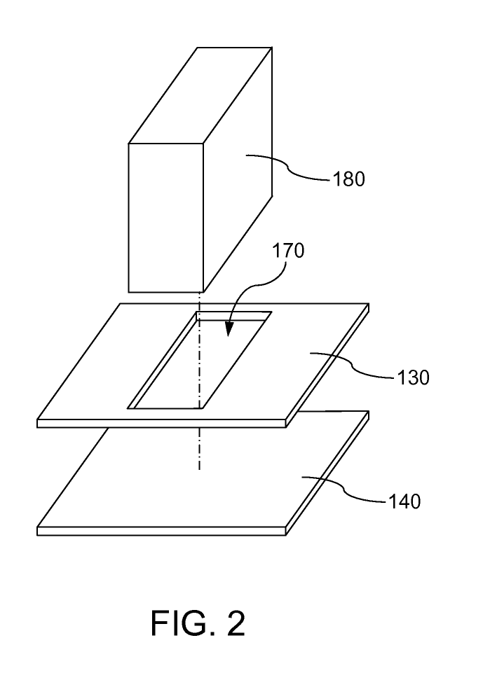

In another embodiment, the upper plate 130 has a hole 170, and the modularized power control device 100 further comprises a heat dissipation fan 180 as shown in FIG. 2.

The heat dissipation fan 180 passes the upper plate 130 through the hole 170, and is supported and fixed on the lower plate 140. The heat dissipation fan 180 can be coupled to the fan control module 142 and operates under the control of the fan control module 142, so that the heat dissipation fan 180 can dissipate heat for the upper plate 130 and the lower plate 140, and thus reduce the heat generated by the circuit elements on the upper plate 130 and the lower plate 140.

In the modularized power control device according to the embodiments, the fan control module and the second voltage converter are integrated on the lower plate, the fan control module is connected to the second voltage converter by the metal lines on the lower plate, and the signal lines of the upper plate are connected to the signal lines of the lower plate by the second connecting unit. Accordingly, the modularized power control device according to the embodiments can transmit signals to the upper plate or receive signals generated by the upper plate.

Furthermore, the upper plate has a hole through which the heat dissipation fan can be installed between the upper plate and the lower plate in order to dissipate heat of the upper plate and the lower plate. Therefore, a number of signal lines can be reduced effectively in order to decrease the use cost of the circuit elements and simplify the design of the power control device.

Note that the specifications relating to the above embodiments should be construed as exemplary rather than as limitative of the present disclosure, with many variations and modifications being readily attainable by a person of average skill in the art without departing from the spirit or scope thereof as defined by the appended claims and their legal equivalents.

What is claimed is:

1. A modularized power control device for a computer system, comprising:
an upper plate having a first voltage converter, the first voltage converter being configured to receive a first voltage and convert the first voltage into a plurality of first operating voltages required by the computer system;
a lower plate having a second voltage converter and a fan control module, the second voltage converter being configured to receive a second voltage and convert the second voltage into a plurality of second operating voltages required by the computer system, the fan control module being configured to control operations of a plurality of heat dissipation fans inside the computer system;
a plurality of power lines disposed on the upper plate and the lower plate respectively, and being coupled to the first voltage converter and the second voltage converter;
a plurality of signal lines disposed on the upper plate and the lower plate respectively, and the signal lines on the lower plate being coupled to the fan control module;
a first connecting unit configured to connect the power lines of the upper plate and the power lines of the lower plate; and
a second connecting unit configured to connect the signal lines of the upper plate and the signal lines of the lower plate.

2. The modularized power control device as claimed in claim 1, wherein the upper plate has a hole, and the modularized power control device further comprises:
a heat dissipation fan passing the upper plate through the hole, the heat dissipation fan being coupled to the fan control module to be controlled by the fan control module for dissipating heat of the upper plate and the lower plate.

3. The modularized power control device as claimed in claim 1, wherein the first connecting unit is a bridging card.

4. The modularized power control device as claimed in claim 1, wherein the second connecting unit is a signal cable or a signal bus.

5. The modularized power control device as claimed in claim 1, wherein the computer system further comprises:
a first power supply unit configured to supply the first voltage; and
a second power supply unit configured to supply the second voltage.
